(19) United States
(12) Patent Application Publication
(10) Pub. No.: US 2025/0237568 A1
(43) Pub. Date: Jul. 24, 2025

(54) WHEEL BALANCER HAVING INTEGRATED LIFT

(71) Applicant: The Coats Company, LLC, LaVergne, TN (US)

(72) Inventor: Andrew Freeman, Hermitage, TN (US)

(21) Appl. No.: 19/034,494

(22) Filed: Jan. 22, 2025

Related U.S. Application Data
(60) Provisional application No. 63/623,641, filed on Jan. 22, 2024.

(51) Int. Cl. G01M 1/04

(52) U.S. Cl. CPC G01M 1/045

(57) ABSTRACT

A method of balancing a wheel assembly comprising providing a wheel balancer having a shaft extending from a chassis, a protective hood, and a selectively extendable lift, the protective hood movable between an engaged position and a disengaged position; supporting the wheel assembly via the lift; extending the lift such that the wheel assembly is lifted until a bore of the wheel assembly is aligned with the shaft; securing the wheel assembly to the shaft; moving the protective hood to the engaged position; automatically lowering the lift such that the lift does not contact the wheel assembly; and initiating a balance cycle wherein the wheel assembly is rotated about the shaft.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD OF THE DISCLOSURE

The present disclosure relates generally to the field of wheel balancers. More particularly, the present invention relates to wheel balancers having integrated lifts and methods of using such.

### CROSS-REFERENCES TO RELATED APPLICATIONS

This application claims the benefit of U.S. Provisional Patent Application No. 63/623,641, filed Jan. 22, 2024.

### BACKGROUND

Electronic wheel balancers are generally well-known in the art. In conventional electronic wheel balancers, the wheel assembly to be balanced is placed on a shaft that extends laterally from a wheel balancer chassis. The shaft is directly or indirectly coupled to an electric drive motor so that the shaft and wheel assembly mounted thereon can be rotated. Imbalance force transducers responsive to mechanical imbalances in the wheel assembly may be mechanically linked to the shaft and motor. These transducers may send electrical signals to a processor which performs predetermined mathematical computations in order to analyze the signals.

After the imbalance signals are processed, a visual indicator is typically provided to the operator identifying a location or locations where correction weights are to be attached. Further, the wheel balancer may indicate an amount of compensating weight to be added to the tire and wheel assembly.

Wheel assembly lifts may be used in connection with the wheel balancer. The wheel assembly lift may be integral to the electronic wheel balancer, or may alternatively be separate but used in connection with the electronic wheel balancer. The wheel assembly lift may be hydraulically powered or electrically powered. The wheel assembly lift may be configured to assist the operator with lifting the wheel assembly for placement on the shaft of the electronic wheel balancer. The operator may selectively lift and lower the wheel assembly via the wheel assembly lift using a variety of controls, such as a foot pedal to name one example. Once the wheel assembly has been secured to the shaft, the operator must lower the wheel assembly lift prior to the shaft rotating the wheel assembly for the balancing cycle. If the wheel assembly lift is not lowered, the tire of the wheel assembly will contact the wheel assembly lift, causing issues with the balancing cycle, safety concerns, and potential damage to equipment.

Accordingly, a need exists for improvements in electronic wheel balancers and wheel assembly lifts used in connection therewith.

### BRIEF SUMMARY

The current disclosure provides an enhancement to conventional wheel balancers and methods of operation thereof, at least in part by introducing a novel wheel balancer with integrated lift and method for balancing a wheel assembly. This Brief Summary is provided to introduce a selection of concepts in a simplified form with respect to those further described below. This Brief Summary is not intended to identify key features or essential features of an invention as disclosed herein, or to otherwise limit the scope of an invention as disclosed herein, unless otherwise specifically noted.

In some aspects, the techniques described herein relate to a wheel balancer for balancing a wheel assembly, the wheel balancer including: a chassis having a shaft extending therefrom; a protective hood coupled to the chassis and movable between an engaged position and a disengaged position; a tire support platform configured to support the wheel assembly; and a lift coupled to the tire support platform and configured to selectively position the tire support platform; wherein the wheel balancer is configured to automatically lower the tire support platform such that the tire support platform does not contact the wheel assembly when the protective hood is moved to the engaged position.

In some aspects, the techniques described herein relate to a wheel balancer, further including: a solenoid valve configured to selectively provide air to the lift; and a hood position switch operably coupled to the protective hood and the solenoid valve; wherein the protective hood in the engaged position engages the hood position switch and closes the solenoid valve.

In some aspects, the techniques described herein relate to a wheel balancer, wherein: the protective hood in the disengaged position opens the solenoid valve.

In some aspects, the techniques described herein relate to a wheel balancer, wherein: the lift further includes: a lift actuator configured to selectively position the lift; and a lift actuator switch coupled to the lift actuator and operable between an activated state and a deactivated state.

In some aspects, the techniques described herein relate to a wheel balancer, wherein: the lift further includes: a base connected to the chassis; and a scissor support structure interposed between the base and the tire support platform and coupled to the lift actuator.

In some aspects, the techniques described herein relate to a wheel balancer, wherein: the lift further includes: a lift actuator operably coupled to the solenoid valve and configured to selectively position the lift; and a lift actuator switch coupled to the lift actuator and operable between an activated state and a deactivated state; wherein an open position of the solenoid valve provides fluid to the lift actuator and is operably associated with the lift actuator switch in the deactivated state.

In some aspects, the techniques described herein relate to a wheel balancer, wherein: the lift actuator includes an air bag.

In some aspects, the techniques described herein relate to a wheel balancer, wherein: the lift actuator includes a pneumatic cylinder or a hydraulic cylinder.

In some aspects, the techniques described herein relate to a wheel balancer, further including: a rack slidably coupled to the tire support platform.

In some aspects, the techniques described herein relate to a wheel balancer, wherein: the shaft includes a rotational axis; the tire support platform includes a guide in which the rack is slidably coupled; and the guide includes a linear axis substantially parallel to the rotational axis.

In some aspects, the techniques described herein relate to a wheel balancer, wherein: the chassis further includes a foot pedal arranged at a lower portion of the chassis and operably associated with a rotational input to the shaft and/or a movement of the lift.

In some aspects, the techniques described herein relate to a wheel balancer, wherein: the shaft extends from a first side surface of the chassis; and the tire support platform is arranged on the first side surface of the chassis.

In some aspects, the techniques described herein relate to a wheel balancer, wherein: the tire support platform is vertically aligned beneath the shaft.

In some aspects, the techniques described herein relate to a method of balancing a wheel assembly, the method including: providing a wheel balancer having a shaft extending from a chassis, a protective hood movable between an engaged position and a disengaged position, and a lift; supporting the wheel assembly via the lift; positioning the lift such that a bore of the wheel assembly is aligned with the shaft; securing the wheel assembly to the shaft; moving the protective hood to the engaged position; based at least on moving the protective hood to the engaged position, automatically lowering the lift such that the lift does not contact the wheel assembly; and initiating a balance cycle wherein the wheel assembly is rotated about the shaft.

In some aspects, the techniques described herein relate to a method, further including: moving the protective hood to the disengaged position; and based at least on moving the protective hood to the disengaged position, automatically raising the lift such that the lift contacts the wheel assembly.

In some aspects, the techniques described herein relate to a method, further including: providing a solenoid valve configured to selectively provide a fluid to the lift; a lift actuator fluidly coupled to the solenoid valve; and based at least on moving the protective hood to the engaged position, closing the solenoid valve and retracting the lift actuator.

In some aspects, the techniques described herein relate to a method, further including: providing an actuator switch operable between an activated state and a deactivated state, the actuator switch coupled to the lift actuator; and automatically initiating the balance cycle when the actuator switch is in the activated state.

In some aspects, the techniques described herein relate to a method, further including: providing a tire support platform coupled to the lift and a rack slidably coupled to the tire support platform; wherein supporting the wheel assembly via the lift further includes supporting the wheel assembly via the tire support platform, the rack, or a combination thereof; and before securing the wheel assembly to the shaft, sliding the rack in a direction of the shaft.

In some aspects, the techniques described herein relate to a method, further including: providing a foot pedal arranged at a lower portion of the chassis; and depressing the foot pedal to selectively position the lift, initiate the balance cycle, stop the balance cycle, or a combination thereof.

In some aspects, the techniques described herein relate to a method, further including: providing a database of selectable wheel assembly attributes; and based on the wheel assembly, selecting one or more attributes from the database; wherein positioning the lift is based at least on the selected one or more attributes.

Numerous objects, features and advantages of a apparatus and method as disclosed herein will be readily apparent to those skilled in the art upon a review of the following description in conjunction with the accompanying drawings.

### BRIEF DESCRIPTION OF THE DRAWINGS

FIG. 1 is a partial schematic view of the wheel balancer having a lift according to an aspect of the present disclosure.

FIG. 2 depicts a schematic view of an exemplary resident controller according to an aspect of the present disclosure.

FIG. 3A depicts an exemplary schematic operational state of the lift extending according to an aspect of the present disclosure.

FIGS. 3A-3B depict exemplary schematic operational states of a lift according to an aspect of the present disclosure.

### DETAILED DESCRIPTION

Reference will now be made in detail to aspects of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one aspect can be used with another aspect to yield a still further aspect.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary aspects only and is not intended as limiting the broader aspects of the present disclosure.

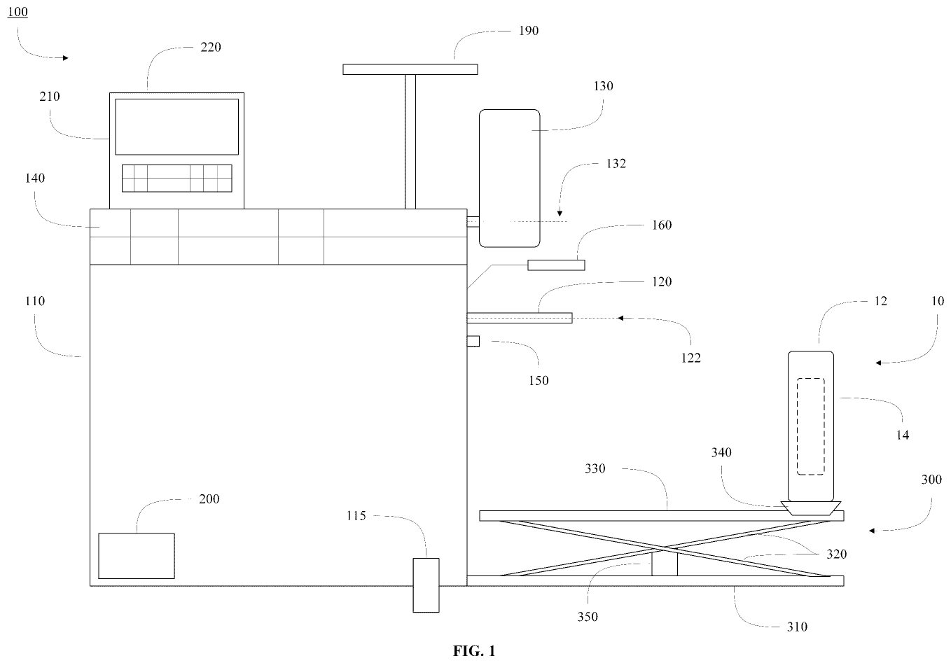

Referring now to FIGS. 1-3B, various embodiments may now be described of a wheel balancing machine with a tire lift and a method of operation thereof.

FIG. 1 depicts an electronic wheel balancer 100 according to an aspect of the present disclosure. The electronic wheel balancer 100 may be configured to detect and identify dynamic and/or static imbalances of a wheel assembly 10 (including a tire 12 and a wheel 14) and provide an operator with data related thereto. The operator may, in response to the data, selectively couple weights to the wheel assembly 10 to correct the identified dynamic and/or static imbalances. In some aspects, the operator may selectively couple weights to the wheel 14, the tire 12, or some combination thereof.

The electronic wheel balancer 100 may include a chassis 110 that may support and enclose an electric motor having a shaft 120 extending outwardly from a side of the chassis 110. While one exemplary chassis 110 is shown in FIG. 1, it is within the spirit and scope of the present disclosure for other chassis 110 to be used. During balancing, a wheel assembly 10 may be mounted to shaft 120 in a conventional manner, such as using a back cone or pressure cap secured with a hub nut. The shaft 120 may be rotated by direct drive, belt drive, or any other suitable configuration to complete a balancing cycle. The shaft 120 may be rotatable relative to the chassis 110 and may define a shaft axis 122 of rotation extending through a longitudinal axis of the shaft 120.

The chassis 110 may include a foot pedal 115 configured to receive an operator input. In some aspects, the foot pedal 115 may include more than one foot pedal, each foot pedal may be separately operable to perform functions disclosed herein. In some aspects, the foot pedal 115 may be operable to perform more than one function disclosed herein. The foot pedal 115 may be coupled to a bottom portion of the chassis 110. The foot pedal 115 may be operable to lock the shaft 120 relative to the chassis 110 such that the shaft 120 does not rotate and unlock the shaft 120 relative to the chassis 110 such that the shaft 120 may rotate. Moreover, the foot pedal 115 may be operable to receive operator input and transmit signals to a controller 200 associated with a user interface 210. In some aspects, the foot pedal 115 may be operable to raise and/or lower a lift 300 as disclosed further herein. The foot pedal 115 may be operable to provide fluid from an external source to the lift 300 as further disclosed herein, including being operable to control the solenoid valve 302, the position of the protective hood 130, or a combination thereof.

A protective hood 130 may be pivotably coupled, either directly or indirectly, to the chassis 110. In some aspects, the protective hood 130 may be pivotably coupled about a hood axis 132. The protective hood 130 may be configured to operate in both a disengaged position and an engaged position. In the disengaged position, the protective hood 130 may be pivotably raised such that a wheel assembly 10 may be mounted on or unmounted from the shaft 120. When the wheel assembly 10 is mounted to the shaft 120 and the protective hood 130 is in the disengaged position, the wheel assembly 10 may be uncovered such that it is accessible the operator. In the engaged position, the protective hood 130 may be pivotably lowered such that at least a portion of a wheel assembly 10 mounted on the shaft 120 is covered by the protective hood 130. Thus, when the protective hood 130 is in the engaged position, it may cover the upper portions of the wheel assembly 10 and provide protection to the operator during high speed rotation of the wheel assembly 10. In some aspects, the foot pedal 115 may be operable to move the protective hood 130 between the engaged and disengaged positions.

A weight tray 140 may be located on a top of the chassis 110. The weight tray 140 may be configured to receive and store various styles and sizes of weights for use by the operator. The operator may selectively couple the weights to the wheel assembly 10, and more specifically to the wheel 14, to correct the identified dynamic and/or static imbalances. In some aspects, the operator may selectively couple the weights to the tire 12, or to both the wheel 14 and the tire 12, to correct the identified dynamic and/or static imbalances.

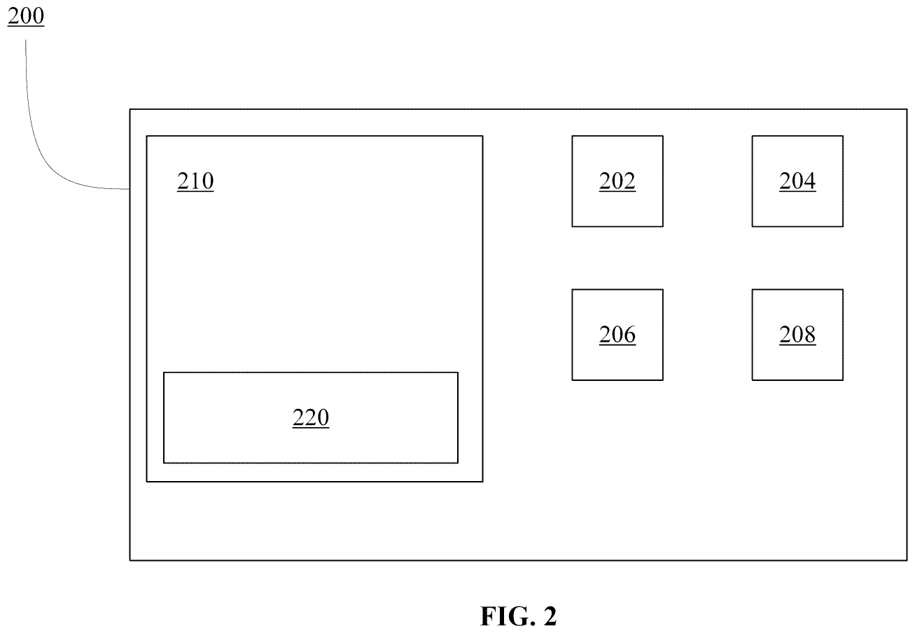

The electronic wheel balancer 100 may include a resident controller 200, as mentioned above. FIG. 2 depicts a schematic view of an exemplary resident controller 200 according to an aspect of the present disclosure. The resident controller 200 may include or be associated with a processor 202, a computer-readable medium 204, a communication unit 206, and data storage 208 such as for example a database network. It is understood that the resident controller 200 described herein may be a single controller having some or all of the described functionality, or it may include multiple controllers wherein some or all of the described functionality is distributed among the multiple controllers.

Various operations, steps or algorithms as described in connection with the resident controller 200 can be embodied directly in hardware, in a computer program product such as a software module executed by the processor 202, or in a combination of the two. The computer program product can reside in RAM memory, flash memory, ROM memory, EPROM memory, EEPROM memory, registers, hard disk, a removable disk, or any other form of computer-readable medium 204 known in the art. An exemplary computer-readable medium 204 can be coupled to the processor 202 such that the processor 202 can read information from, and write information to, the memory/storage medium 204. In the alternative, the medium 204 can be integral to the processor 202. The processor 202 and the medium 204 can reside in an application specific integrated circuit (ASIC). The ASIC can reside in a user terminal. In the alternative, the processor 202 and the medium 204 can reside as discrete components in a user terminal.

The term “processor” 202 as used herein may refer to at least general-purpose or specific-purpose processing devices and/or logic as may be understood by one of skill in the art, including but not limited to a microprocessor, a microcontroller, a state machine, and the like. A processor 202 can also be implemented as a combination of computing devices, e.g., a combination of a DSP and a microprocessor, a plurality of microprocessors, one or more microprocessors in conjunction with a DSP core, or any other such configuration.

The communication unit 206 may support or provide communications between the resident controller 200 and external communications units, systems, or devices, and/or support or provide communication interface with respect to components of the electronic wheel balancer 100. The communication unit 206 may include wireless communication system components (e.g., via cellular modem, WiFi, Bluetooth or the like) and/or may include one or more wired communications terminals such as universal serial bus ports.

The data storage 208 may, unless otherwise stated, generally encompass hardware such as volatile or non-volatile storage devices, drives, electronic memory, and optical or other storage media, as well as in certain aspects one or more databases residing thereon. In an optional aspect, the data storage 208 may be configured to receive and retrievably store data sets, models, and/or algorithms, for further performing programmatic operations or the like as further disclosed herein.

In some aspects, the electronic wheel balancer 100 may provide a database of selectable wheel assembly attributes that allows an operator to select one or more attributes from the database. Each of these attributes may correspond to a physical dimension or characteristic associated with a wheel assembly 10. In an exemplary aspect, the electronic wheel balancer 100 may include a catalogue of physical characteristics associated with various wheels and tires, some of which may be present in the wheel assembly 10 to be balanced. In some aspects, the structures associated with the position of the lift 300 when raising or lowering the lift may be configured to alter the position of the lift 300 based on the selected attributes of the wheel assembly 10. In an exemplary aspect, the dimensions associated with the tire 12 and the wheel 14 may be selected to provide the selective positioning of the lift 300.

The electronic wheel balancer 100 may include various electronic components associated with the balancing process. Each of the electronic components may be connected or otherwise associated, either wirelessly or via a wired connection, to the controller 200. In certain optional aspects, the electronic wheel balancer 100 may include a sensor 190. The sensor 190 may be a single sensor or may alternatively include a plurality of sensors. The plurality of sensors may be located within a single housing, or alternatively located within separate housings.

In accordance with certain aspects of the disclosure, the sensor 190 may be located adjacent to the shaft 120. The sensor 190 may be pivotably and/or extendably attached to the side of the chassis 110 from which the shaft 120 extends via a sensor arm. The sensor 190 may be configured to be selectively located at least partially within the wheel 14 of the wheel assembly 10 when the wheel assembly 10 is mounted on the shaft 120. In accordance with other aspects of the disclosure, the sensor 190 may be mounted above the chassis 110, shaft 120, and/or protective hood 130. The sensor 190 may be configured to collect data related to the wheel assembly 10. For example, the sensor 190 may automatically determine the shape and dimensions of the wheel 14 and identify planes where weights may be mounted.

In some aspects, the sensor 190 may include a light source and an optical detector with a field of view. The sensor 190 may be provided as a module to be coupled to the chassis 110, the protective hood 130, or other structure of the electronic wheel balancer 100 that provide a field of view of the sensor 190 encompassing the wheel assembly 10 when mounted on the shaft 120. In some aspects, the sensor 190 may be rotationally mounted to enable rotation of the sensor 190 relative to the wheel assembly 10.

The electronic wheel balancer 100 may include a laser 150. The laser 150 may be operable to produce a visual marker on the wheel 14 thus indicating a placement position for coupling weights. The laser device may be selectively activated by the operator when desired.

In some aspects, the laser 150 may be fixedly coupled to the sensor 190 to provide for coordinated movement of the laser 150 and the sensor 190. In an exemplary aspect, the laser 150 and the sensor 190 may be fixedly coupled together in a module, which module may be rotationally mounted to the electronic wheel balancer 100.

The electronic wheel balancer 100 may include a load roller 160. The load roller 160 may be pivotably coupled to the chassis 110 such that the load roller 160 may selectively engage a tread surface of a tire 12 mounted on the shaft 120. The load roller 160 may be configured to collect data related to the wheel assembly 10, such as the detection of high spots on the tread surface of the tire 12.

In some aspects, the load roller 160 may include one or more of the sensor 190 configured to measure a position of the load roller 160, a force experienced by the load roller 160, or some combination of both. The load roller 160 may include, but is not limited to, load cells, force sensors (including piezoelectric and capacitive type), displacement sensors, rotary encoders, or any combination thereof to sense positions and forces as a result of rotation of the wheel assembly 10 on the shaft 120. In an exemplary aspect, the load roller 160 may include a sensor configured to measure a position of the load roller 160 throughout rotation of the wheel assembly 10. In some aspects, the information obtained from the load roller 160, including the positional measurements of the wheel assembly 10 as the wheel assembly rotates, may be stored in the data storage 208.

The controller 200 may be configured to produce outputs to user interface 210 associated with a display unit 220 for display to an operator. The display unit 220 may be conventionally coupled to and located above chassis 110. The controller 200 may be configured to receive inputs from the user interface 210, such as user input provided via interface tools (e.g., keyboard, touch screen, buttons) associated with the user interface 210. The controller 200 may in accordance with certain aspects of the disclosure further receive inputs from and generate outputs to remote devices, such as the sensor 190, associated with the electronic wheel balancer 100 via a mobile computing device or the like.

The electronic wheel balancer 100 may include or be associated with a lift 300. In some aspects, the lift 300 may include manual lift mechanisms, hydraulic mechanisms, pneumatic mechanisms, electric mechanisms, mobile platforms, scissor lift type, telescopic lift type, or a combination thereof. a person of ordinary skill in the art may appreciate a lift distinct from the exemplary structures and functions disclosed herein but nonetheless configured to raise the tire support platform 330 and wheel assembly 10 from a ground, roller, or other supporting surface. Wheel assembly lift or hoist mechanisms in wheel balancing machines may be broadly categorized into manual, hydraulic, pneumatic, and electric types, each utilizing a wheel platform to assist in lifting heavy wheel assemblies. Manual lifts rely on physical effort, while hydraulic and pneumatic lifts use fluid pressure or compressed air, respectively, to provide smooth, controlled lifting with minimal exertion. Electric lifts offer precise control and ease of use, ideal for high-volume operations. Integrated lift systems, often found in advanced wheel balancers, seamlessly combine lifting with other machine functions, enhancing efficiency.

In various aspects, lifts can be either fixed or mobile, depending on the design. Fixed position platforms provide stability, particularly for large tires, while mobile platforms offer flexibility in positioning around the wheel balancer. Scissor and telescopic lift designs further enhance versatility by offering compact or extended lifting capabilities, catering to various tire sizes and shop environments. Each type of lift is designed to improve the wheel balancing process by reducing physical strain and increasing operational efficiency.

In some aspects, the lift 300 may raise the wheel assembly 10 from a ground or other supporting surface to an operating component of the electronic wheel balancer 100, including the shaft 120, the protective hood 130, the laser 150, the load roller 160, the sensor 190, or a combination thereof.

The lift 300 may also be referred to herein as a wheel assembly lift 300. In accordance with certain aspects of the disclosure, the lift 300 may be coupled to the bottom portion of the chassis 110. The lift 300 may extend from the same side of the chassis 110 as the shaft 120. The lift 300 may include a base 310, a scissor support structure 320, a tire support platform 330, and an lift actuator 350. The base 310 may support the lift 300 from a ground surface. The base 310 may be connected to the tire support platform 330 by the scissor support structure 320. The scissor support structure 320 may be selectively extendable such that the distance between the base 310 and the tire support platform 330 changes. The lift actuator 350 may be operable to selectively extend and retract the scissor support structure 320. A rack 340 may be slidably coupled to the tire support platform 330 such that the rack 340 may translate relative to the tire support platform 330. Thus, when a wheel assembly 10 is supported by the tire support platform 330 atop the rack 340, the wheel assembly 10 may be easily translated relative to the tire support platform 330 and the shaft 120.

The lift 300 may be operable in an extended position and a collapsed position. When the lift 300 is in the collapsed position, the tire support platform 330 may be collapsed against the base 310 such that a wheel assembly 10 may easily be rolled onto the tire support platform 330. When the lift 300 is moved to the extended position, the wheel assembly 10 supported by the tire support platform 330 may be raised into the air. The tire support platform 330 may be selectively raised until the wheel assembly 10 is at a desirable height to be slid onto the shaft 120. The scissor support structure 320 may be selectively extended and the tire support platform 330 lifted by the lift actuator 350. The lift actuator 350 may be an air bag, hydraulic cylinder, servo, or the like.

In accordance with other aspects of the disclosure, the lift 300 may include the tire support platform 330 supported only by the chassis 110. The lift 300 may not include the scissor support structure 320 or the tire support platform 330. The chassis 110 may selectively raise and lower the tire support platform 330 and thus the wheel assembly 10 relative to the chassis 110. The tire support platform 330 may be lifted by lift actuator 350 housed within the chassis 110.

In accordance with certain aspects of the disclosure, the lift 300 may be controlled by an operator via the user interface 210. The lift 300 may include an independent controller that may be connected to the resident controller 200 of the electronic wheel balancer 100. Alternatively, the lift 300 may be connected directly to the controller 200 of the electronic wheel balancer 100 without an independent controller. An operator may control the lift 300 via interface tools (e.g., keyboard, touch screen, buttons) associated with the display unit 220. In accordance with other aspects of the disclosure, the lift 300 may be controlled via interface tools that are separate and disconnected from the controller 200. For example, in an aspect of the lift 300 wherein the lift actuator 350 is an air bag, a switch may be operable to selectively inflate and deflate the air bag, thus raising and lowering the tire support platform 330 and wheel assembly 10. In another example, in an aspect of the lift 300 wherein the lift actuator 350 is a hydraulic cylinder, a switch may be operable to selectively extend or retract the hydraulic cylinder, thus raising and lowering the tire support platform 330 and wheel assembly 10.

In some aspects, the lift actuator 350 may include a lift actuator switch 352 coupled to the lift actuator 350 and operable between an activated state and a deactivated state. The lift actuator switch 352 may include any suitable switch associated with detecting changes in position of the lift 300. In an exemplary aspect where the lift actuator 350 is provided as a cylinder, various contact or non-contact type switches may be employed to detect the degree of extension or retraction of the lift actuator 350 by presence of a switch actuator attached to the piston rod 354 and a corresponding switch receiver attached to the cylinder 356. The positions and locations of the switch actuator and switch receiver may be modified and still fall within the scope of the presently disclosed lift actuator switch 352. These switches may include, but are not limited to, mechanical limit switches, magnetic reed switches, inductive proximity sensors, hall effect sensors, optical sensors, linear potentiometer switches, or magnetic position sensors.

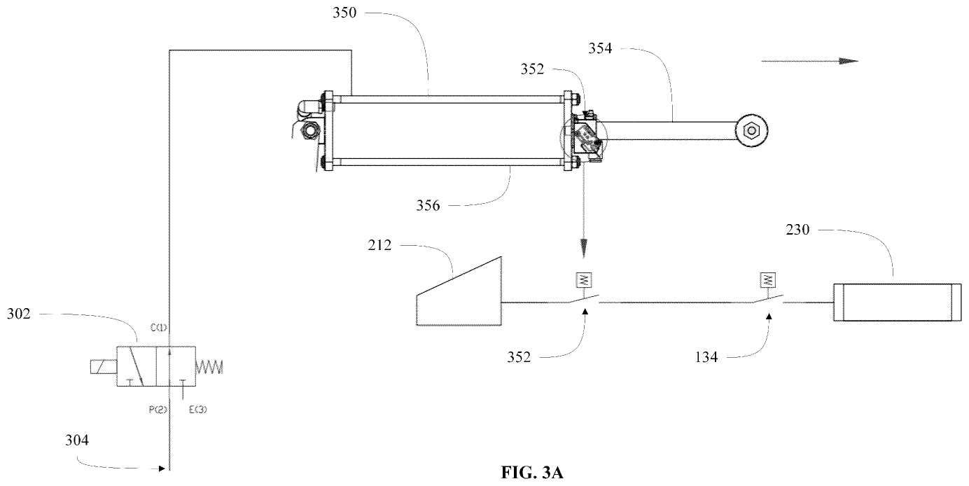

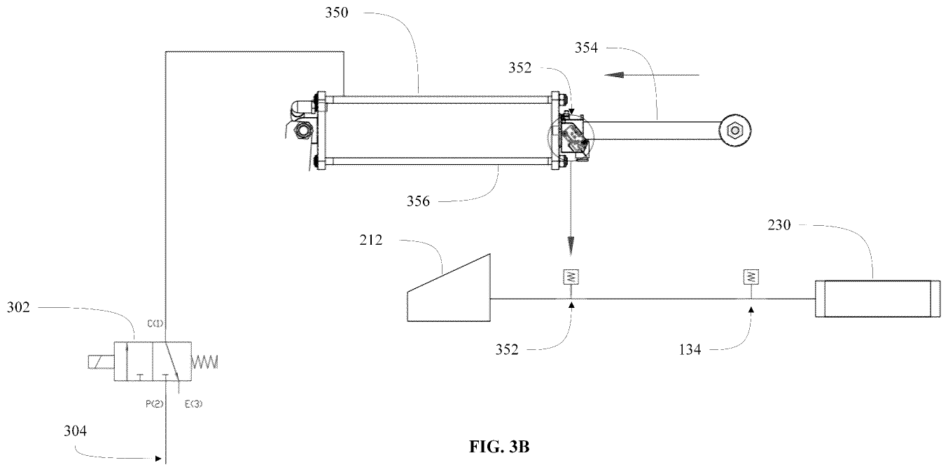

FIGS. 3A-3B depict exemplary schematic operational states of a lift according to an aspect of the present disclosure. The electronic wheel balancer 100 may include a solenoid valve 302 configured to provide fluid communication between the lift 300 and an external source 304. In some aspects, the solenoid valve 302 may be a pneumatic solenoid valve in fluid communication with a fluid distribution network, a fluid reservoir, or other pneumatic source as the external source 304. In an exemplary aspect, the external source 304 may be provided as shop air or a pneumatic reservoir. The solenoid valve 302 may be configured to selectively provide air or another fluid to the lift 300 based on a command signal associated with the controller 200. In other aspects, the solenoid valve 302 and the lift 300 may be provided as a hydraulic system utilizing control of hydraulic fluid.

In some aspects, a position of the solenoid valve 302 may be operably associated with signals representative of the position of the protective hood 130. FIG. 3A depicts an exemplary schematic operational state of the lift 300 extending according to an aspect of the present disclosure.

The protective hood 130 may be operatively coupled to the lift 300. In some aspects, the protective hood 130 may include a hood position switch 134 configured to generate a position signal representative of the position of the protective hood 130. The hood position switch 134 may be of any suitable type to detect a rotational position of the protective hood 130 relative to the hood axis 132, including any of the previous types of switches previously disclosed herein. When the protective hood 130 is in the disengaged position, the lift 300 may be free to move between the extended and collapsed positions. Thus, the operator may load a wheel assembly 10 onto the tire support platform 330 of the lift 300 while the lift 300 is in the collapsed position. The operator may then cause the lift 300 to extend such that the tire support platform 330 and the wheel assembly 10 supported thereby is lifted into the air. When the wheel assembly 10 is at an appropriate height relative to the shaft 120, the operator may translate the wheel assembly 10 relative to the tire support platform 330 by moving the rack 340 towards the shaft 120. Once the wheel assembly 10 is mounted onto the shaft 120, the operator may move or cause the protective hood 130 to move to the engaged position where it partially covers the wheel assembly 10. When the protective hood 130 is moved into the engaged position, the electronic wheel balancer 100 may automatically lower the tire support platform 330 of the lift 300 such that it no longer contacts the tire 12 of the wheel assembly 10. Thus, the hood position switch 134 may be operably coupled to the protective hood 130 and the solenoid valve 302.

The electronic wheel balancer 100 may automatically cause the lift actuator 350 to lower the tire support platform 330 of the lift 300 via various methods and operations. In accordance with certain aspects of the disclosure, a switch associated with the protective hood 130 may be used to initiate a solenoid that controls air flow to a pneumatic valve associated with the lift 300. The pneumatic valve may cause the tire support platform 330 to lower away from the wheel assembly 10. Thus, the wheel assembly 10 may be rotated by the shaft 120 through a balancing cycle without contacting the tire support platform 330. In accordance with other aspects of the disclosure wherein the lift actuator 350 is a hydraulic cylinder, lowering the protective hood 130 into the engaged position may cause the hydraulic cylinder to retract a desired amount, thus lowering the tire support platform 330 away from the wheel assembly 10 mounted on the shaft. Thus, the wheel assembly 10 may be rotated by the shaft 120 through a balancing cycle without contacting the tire support platform 330.

In accordance with certain aspects of the disclosure, the protective hood 130 may contact a physical switch, button, or similar interface when the protective hood 130 is lowered into the engaged position. In an exemplary aspect, the physical switch, button, or similar interface may include a hood position switch 134. The physical switch, button, or similar interface may cause the tire support platform 330 of the lift 300 to lower by deflating the air bag, retracting the hydraulic cylinder, or other applicable actions. In accordance with other aspects of the disclosure, a sensor may detect when the protective hood 130 is lowered into the engaged position. In some aspects, the hood position switch 134 may be provided to detect when the protective hood 130 is lowered into the engaged position. The sensor may cause the tire support platform 330 of the lift 300 to lower or may transmit a signal to the controller 200 which in turn may lower the tire support platform 330 of the lift 300.

The controller 200 may be configured to detect, via sensors or otherwise, when the tire support platform 330 of the lift 300 has been lowered such that it is no longer in contact with the wheel assembly 10. The controller 200 may be configured to only initiate a balance cycle wherein the wheel assembly 10 is rotated on the shaft 120 when the tire support platform 330 has been lowered. The controller 200 may be configured to alert the operator if the operator attempts to initiate a balance cycle while before the tire support platform 330 has been lowered.

In an exemplary aspect, the protective hood 130 may be moved to the disengaged position. In the disengaged position, the protective hood 130 may contact a hood position switch 134 activated when the protective hood 130 is in the disengaged position. In this manner, the hood position switch 134 may be characterized as a hood “up” switch. In other aspects, the protective hood 130 may activate the hood position switch 134 only when the protective hood 130 is in the engaged position such that when the protective hood 130 is moved to any position other than the engaged position, the hood position switch 134 is deactivated. In this manner, the hood position switch 134 may be characterized as a hood “down” switch. As depicted in FIG. 3A, the protective hood 130 in the disengaged position may deactivate the hood position switch 134 and may provide a voltage to the solenoid valve 302 and allow flow from the external source 304 through the solenoid valve 302 to the lift actuator 350. The input of flow to the lift actuator 350 may extend the lift actuator 350 and may deactivate the lift actuator switch 352. In some aspects, the presence of the lift actuator switch 352 in a deactivated state and the hood position switch 134 in the deactivated state may prevent an operator input 212 from initiating a balance cycle 230. Those of ordinary skill in the art may appreciate the hood position switch 134 and the lift actuator switch 352 may be arranged in such a manner to provide for activated states during retraction of the lift actuator 350 and the protective hood 130 being provided in the engaged position, during extension of the lift actuator 350 and the protective hood 130 being provided in the disengaged position, or permutations thereof based on preference and physical arrangement of switches.

As depicted in FIG. 3B, the protective hood 130 in the engaged position may activate the hood position switch 134 and may provide zero voltage to the solenoid valve 302 to close the solenoid valve 302 and prevent flow from the external source 304 through the solenoid valve 302 to the lift actuator 350. The lack of flow from the solenoid valve 302 to the lift actuator 350 may exhaust the lift actuator 350 and retract the lift actuator 350. As the lift actuator 350 retracts, the lift actuator switch 352 may then become activated. Where the protective hood 130 is in the engaged position as indicated by the activated hood position switch 134, and where the lift actuator 350 is sufficiently retracted such that the lift actuator switch 352 is activated, an operator input 212 initiating a balance cycle 230 may be allowed and begin rotation of the wheel assembly 10 about the shaft 120.

Another aspect of the present disclosure is a method of balancing a wheel assembly 10. The protective hood 130 may be placed in the disengaged position wherein the protective hood 130 is raised up allowing for a wheel assembly 10 to be mounted to the shaft 120. The lift 300 may be placed in the collapsed position wherein a wheel assembly 10 may be easily rolled onto the tire support structure 330 of the lift 300. A back cone may be placed on the shaft 120 that corresponds to the specific wheel assembly 10 being balanced.

An operator may place a wheel assembly 10 onto the tire support platform 330 of the lift 300. More specifically, the operator may roll the wheel assembly 10 onto the rack 340 of the tire support platform 330. The operator may then raise the lift 300, via the lift actuator 350, into the extended position. The operator may raise the lift 300 via interface tools (e.g., keyboard, touch screen, buttons) that may be associated with the user interface 210. The operator may raise the lift 300 via a switch or like device that may or may not be associated with the user interface 210. In some aspects, the operator may raise the lift 300 via the foot pedal 115. The lift actuator 350 may raise the scissor support structure 320, tire support platform 330, and wheel assembly 10 into the air. In certain exemplary aspects having an air bag, the air bag will inflate. In other exemplary aspects having a hydraulic cylinder, the hydraulic cylinder will extend.

The operator may cause the lift actuator 350 to raise the tire support platform 330 and wheel assembly 10 until a center bore of the wheel assembly 10 aligns with the shaft 120. If the operator raises the tire support platform 330 and wheel assembly 10 too high, the operator may cause the lift actuator 350 to lower the tire support platform 330 and wheel assembly 10. The operator may adjust the height of the tire support platform 330 and wheel assembly 10 as needed. The operator may then push the rack 340 and wheel assembly 10 toward the chassis 110 and shaft 120. The rack 340 may translate relative to the tire support platform 330. In some aspects, the tire support platform 330 may include a guide rail (not shown) in which the rack 340 is slidably coupled. The guide rail may provide a track to direct and control the movement of the rack 340 to a specific path associated with the shape, size, and position of the guide. The rack 340 may be slidably coupled to the guide using sliders, rollers, or bearings that are arranged in the rail. In an exemplary aspect, the guide is provided as a line substantially parallel to the shaft axis 122 (rotational axis) of the shaft 120.

The operator may cause the wheel assembly 10 to receive the shaft 120 through the center bore of the wheel assembly 10 such that the wheel assembly 10 is mounted on the shaft 120. The operator may secure the wheel assembly 10 to the shaft 120 in a conventional manner, such as using a back cone or pressure cap secured with a hub nut.

The operator may lower the protective hood 130 into the engaged position. In the engaged position, the protective hood 130 may partially surround the wheel assembly 10 such that the operator and equipment in the adjacent area may be protected from debris that may come off the wheel assembly 10 when rotated. When the protective hood 130 is lowered into the engaged position, the lift actuator 350 may lower the tire support platform 330 such that the tire support platform 330 no longer supports or otherwise contacts the wheel assembly 10. In accordance with certain aspects of the disclosure, when moved into the engaged position, the protective hood 130 may contact a physical switch or like device that causes the lift actuator 350 to lower the tire support platform 330. In accordance with other aspects of the present disclosure, a sensor may detect that the protective hood 130 has been moved into the engaged position and cause the lift actuator 350 to lower the tire support platform 330. The lift actuator 350 may be an air bag, hydraulic cylinder, servo motor, or the like.

The operator may then initiate a balance cycle via the interface tools of the user interface 210. The controller 200 of the electronic wheel balancer 100 may only initiate the balance cycle when the tire support platform 330 has been lowered. The controller 200 may alert the operator if the operator attempts to initiate the balance cycle while before the tire support platform 330 has been lowered.

Once the balance cycle is complete, the electronic wheel balancer 100, via at least the laser 150, may indicate where corrective weights should be added to the wheel 14 to correct imbalances of the wheel assembly 10. The operator may add corrective weights to the wheel 14 as desired. With the protective hood 130 in the engaged position, the operator may initiate another cycle of the electronic wheel balancer 100 to check that the corrected wheel assembly 10 is balanced.

The operator may move the protective hood 130 into the disengaged position and raise the tire support platform 330 of the lift 300 until it supports/contacts the wheel assembly 10. The operator may release the wheel assembly 10 from the shaft 120, for example, by removing the hub nut. The operatory may then, via the rack 340 of the lift 300, remove the wheel assembly 10 from the shaft 120. The tire support platform 330 may then be lowered via the lift actuator 350 such that the wheel assembly 10 may be easily removed from the lift 300.

It is within the scope of the present disclosure for certain steps described in connection with the method of balancing the wheel assembly 10 to be performed in an alternative sequence or for certain steps to be omitted.

Accordingly, the electronic wheel balancer 100 of the present disclosure has several advantages over the prior art. One exemplary advantage may be that the electronic wheel balancer 100, in combination with the lift 300, ensures the tire support platform 330 is lowered such that it does not contact the wheel assembly 10 when the wheel assembly 10 is rotated for the balance cycle. The electronic wheel balancer 100 removes the risk that an operator may forget to lower the lift 300. Another exemplary advantage is that the electronic wheel balancer 100 may decrease the overall cycle time of balancing a wheel assembly 10.

The words “connected,” “attached,” “joined,” “mounted,” “fastened,” and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or multiple components.

As used herein, the phrase “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item Band item C. As used herein, the articles “a,” “an,” and “the” are intended to include one or more unless explicitly state otherwise or required by context.

The terms “substantially” and “generally” are defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the terms ‘substantially straight’ and ‘substantially parallel’ are intended to describe orientations or configurations that are generally straight or parallel, but may allow for minor deviations from absolute straightness or parallelism. Such deviations may arise due to manufacturing tolerances, material properties, or functional requirements of the invention. Accordingly, these terms encompass configurations that are, for practical purposes, straight or parallel, even if small degrees of curvature, angulation, or variation are present that do not materially affect the overall performance or functionality of the claimed invention.

The terms “about” and “approximately” shall generally mean an acceptable degree of error for the quantity measured given the nature or precision of the measurements. Typically, exemplary degrees of error are within 20 percent (%), preferably within 10%, and more preferably within 5% of a given value or range of values. Numerical quantities given herein are approximate unless stated otherwise, meaning that the term “about” or “approximately” can be inferred when not expressly stated.

Thus, it is seen that the apparatus and methods of the present disclosure readily achieve the ends and advantages mentioned as well as those inherent therein. While certain preferred aspects of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or aspect may be combined with any of the other disclosed features or aspects.

What is claimed is:

1. A wheel balancer for balancing a wheel assembly, the wheel balancer comprising:
a chassis having a shaft extending therefrom;
a protective hood coupled to the chassis and movable between an engaged position and a disengaged position;
a tire support platform configured to support the wheel assembly; and
a lift coupled to the tire support platform and configured to selectively position the tire support platform;
wherein the wheel balancer is configured to automatically lower the tire support platform such that the tire support platform does not contact the wheel assembly when the protective hood is moved to the engaged position.

2. The wheel balancer of claim 1, further comprising:
a solenoid valve configured to selectively provide air to the lift; and
a hood position switch operably coupled to the protective hood and the solenoid valve;
wherein the protective hood in the engaged position engages the hood position switch and closes the solenoid valve.

3. The wheel balancer of claim 2, wherein:
the protective hood in the disengaged position opens the solenoid valve.

4. The wheel balancer of claim 1, wherein:
the lift further comprises:
a lift actuator configured to selectively position the lift; and
a lift actuator switch coupled to the lift actuator and operable between an activated state and a deactivated state.

5. The wheel balancer of claim 4, wherein:
the lift further comprises:
a base connected to the chassis; and
a scissor support structure interposed between the base and the tire support platform and coupled to the lift actuator.

6. The wheel balancer of claim 2, wherein:
the lift further comprises:
a lift actuator operably coupled to the solenoid valve and configured to selectively position the lift; and
a lift actuator switch coupled to the lift actuator and operable between an activated state and a deactivated state;
wherein an open position of the solenoid valve provides fluid to the lift actuator and is operably associated with the lift actuator switch in the deactivated state.

7. The wheel balancer of claim 4, wherein:
the lift actuator comprises an air bag.

8. The wheel balancer of claim 4, wherein:
the lift actuator comprises a pneumatic cylinder or a hydraulic cylinder.

9. The wheel balancer of claim 1, further comprising:
a rack slidably coupled to the tire support platform.

10. The wheel balancer of claim 9, wherein:
the shaft comprises a rotational axis;
the tire support platform comprises a guide in which the rack is slidably coupled; and
the guide comprises a linear axis substantially parallel to the rotational axis.

11. The wheel balancer of claim 1, wherein:
the chassis further comprises a foot pedal arranged at a lower portion of the chassis and operably associated with a rotational input to the shaft and/or a movement of the lift.

12. The wheel balancer of claim 1, wherein:
the shaft extends from a first side surface of the chassis; and
the tire support platform is arranged on the first side surface of the chassis.

13. The wheel balancer of claim 1, wherein:
the tire support platform is vertically aligned beneath the shaft.

14. A method of balancing a wheel assembly, the method comprising:
providing a wheel balancer having a shaft extending from a chassis, a protective hood movable between an engaged position and a disengaged position, and a lift;
supporting the wheel assembly via the lift;
positioning the lift such that a bore of the wheel assembly is aligned with the shaft;
securing the wheel assembly to the shaft;
moving the protective hood to the engaged position;
based at least on moving the protective hood to the engaged position, automatically lowering the lift such that the lift does not contact the wheel assembly; and
initiating a balance cycle wherein the wheel assembly is rotated about the shaft.

15. The method of claim 14, further comprising:
moving the protective hood to the disengaged position; and
based at least on moving the protective hood to the disengaged position, automatically raising the lift such that the lift contacts the wheel assembly.

16. The method of claim 15, further comprising:
providing a solenoid valve configured to selectively provide a fluid to the lift; a lift actuator fluidly coupled to the solenoid valve; and
based at least on moving the protective hood to the engaged position, closing the solenoid valve and retracting the lift actuator.

17. The method of claim 16, further comprising:
providing an actuator switch operable between an activated state and a deactivated state, the actuator switch coupled to the lift actuator; and
automatically initiating the balance cycle when the actuator switch is in the activated state.

18. The method of claim 14, further comprising:
providing a tire support platform coupled to the lift and a rack slidably coupled to the tire support platform;
wherein supporting the wheel assembly via the lift further comprises supporting the wheel assembly via the tire support platform, the rack, or a combination thereof; and
before securing the wheel assembly to the shaft, sliding the rack in a direction of the shaft.

19. The method of claim 14, further comprising:
providing a foot pedal arranged at a lower portion of the chassis; and
depressing the foot pedal to selectively position the lift, initiate the balance cycle, stop the balance cycle, or a combination thereof.

20. The method of claim 14, further comprising:
providing a database of selectable wheel assembly attributes; and
based on the wheel assembly, selecting one or more wheel assembly attributes from the database;
wherein positioning the lift is based at least on the selected one or more wheel assembly attributes.
